(19) United States
(12) Patent Application Publication
(10) Pub. No.: US 2005/0007450 A1
(43) Pub. Date: Jan. 13, 2005

(54) Vehicle mounted system and method for capturing and processing physical data

(76) Inventors: Duane Hill, Logan, UT (US); Ray Walker, Huntsville, UT (US); Dan Breene, Lake Oswego, OR (US); Jack Sanders-Reed, Albuquerque, NM (US); Bob Van Allen, Albuquerque, NM (US)

Correspondence Address: BRENT T. WINDER;JONES WALDO HOLBROOK & McDONOUGH, Suite 1500, 170 South Main Street, Salt Lake City, UT, 84101-1644, US

(21) Appl. No.: 10/735,528

(22) Filed: Dec. 12, 2003

Related U.S. Application Data
(60) Provisional application No. 60/433,463, filed on Dec. 13, 2002.

(51) Int. Cl. H04N 7/18

(52) U.S. Cl. 348/142; 348/143

(57) ABSTRACT

A system and method for collecting and processing physical data obtained by various detection devices mounted to a vehicle, such as an aerial craft. Specifically, the present illustrated embodiment(s) involve the use of an aerial craft, such as a helicopter, to capture continuous visual, spatial, and related physical data, and a method for selecting certain representative pieces of the captured unprocessed data to create a discrete stream of processed data. The discrete data stream may then be analyzed and any defects and/or anomalies may be identified within the physical data.

### PRIORITY INFORMATION

This application is based on, and claims priority to, the provisional application filed Dec. 13, 2002 entitled “PROCESS FOR COLLECTING, ANALYZING, AND DELIVERING A DISCRETE DATA STREAM FROM A CONTINUOUS STREAM OF DATA”, Ser. No. 60/433,463, as submitted by inventors Duane Hill et al.

### FIELD OF THE INVENTION

The present invention relates generally to a system and method for collecting and processing physical data obtained by various detection devices mounted to a vehicle, such as an aerial craft. Specifically, the present illustrated embodiment(s) involve the use of an aerial craft, such as a helicopter, for collection of continuous visual, spatial, and related physical data, and a method for selecting certain representative pieces of the data to create a discrete stream of data, wherein global positioning system (“GPS”) data is associated with every individual piece of the discrete data stream.

### BACKGROUND OF THE INVENTION

In the transmission of electrical power, high voltage conductors are supported on a succession of towers along a power corridor, often extending through geographically remote areas. It is necessary to inspect the power lines on a regular basis to monitor both the physical condition of the line and the corridor through which they extend. For example, and by way of illustrative purposes only, the condition of the power line holding insulators need to be inspected for pitting or breakage; the condition of the power lines need to be inspected for breaks in the protective coating or layers; the right-of-way easements and encroachment of trees into the power corridor need to be constantly monitored to watch for potential trees that could fall and damage the power lines; and the structural integrity of wooden power poles needs to be inspected, which are often damaged from animals or birds, such as wood peckers, that have been known to cause damage. Inspections may also need to be conducted immediately after storms to monitor damage from sudden high winds, heavy ice formations, or heavy snow falls.

As is typically followed by known methods, inspectors visually monitor the power corridor for damage by driving along the closest roadways or actually walk the length of the power line and take notes by hand. Other known methods of power line inspection include those methods and systems cited in the list of prior art citations provided below. However, there are many problems associated with these known methods of data collection and with other methods identified in the prior art of record, which are made more obvious to one skilled in the art after review of the illustrated embodiment(s). For example, and by way of illustration only, the prior art additionally identifies data collection methods and devices that use a combination of fly-overs and foot patrols using visual inspection and specific sensors that collect millions of pieces of data. This data is then stored and later analyzed by a person that manually reviews each piece, or page, of data to identify anomalies or defects. For example, damage often occurs to the bell portions of a transformer or power pole, which can create significant electrical loss and leakage in a line. Further, structural damage can compromise the strength of power structures and can eventually lead to line failure or collapse.

Under known methods, this laborious process can often take years to complete, which significantly reduces the efficiency of the power grid and costs utility providers thousands, if not millions, of dollars in lost resources. This cost is eventually passed on to consumers. To further the problems created by a slow and tedious inspection routine, it has been held that much of the data that is collected and entered manually is never reviewed because the review process is so cumbersome and time consuming.

Therefore, and by way of illustration only, there has been established a need in the prior art for a system and method for collecting physical ground data, such as the condition and location of power transmission lines, at relatively high speed that is designed and configured to process the data into discrete portions identifying specific anomalies or defects within the physical target range.

The following United States patents are herein incorporated by reference for their supporting teachings:
1) U.S. Pat. No. 6,363,161 B2, is a system for automatically generating database of objects of interest by analysis of images recorded by moving vehicles.
2) U.S. Patent No. Pub. No.: US 2001/0036293A1, is a system for automatically generating database of objects of interest by analysis of images recorded by moving vehicle.
2) U.S. Pat. No. 6,028,948 is a surface anomaly-detection and analysis method.
3) U.S. Pat. No. 6,343,290 B1, is a geographic network management system.
4) U.S. Pat. No. 6,453,056 B2, is a method and apparatus for generating a database of road sign images and positions.
5) U.S. Pat. No. 6,422,508 B1, is a system for robotic control of imaging data having a steerable gimbal mounted spectral sensor and methods.
6) U.S. Pat. No. 6,449,384 B2, is a method and apparatus for rapidly determining whether a digitized image frame contains an object of interest.
7) U.S. Pat. No. 5,894,323 is an airborne imaging system using global positioning system and inertial measurement units (IMU) data.
8) U.S. Pat. No. 6,266,442 B1, is a method and apparatus for identifying objects depicted in a videostream.
9) U.S. Pat. No. 4,818,990, is a monitoring system for power lines and right-of-ways using remotely piloted drones.
10) U.S. Pat. No. 5,742,517, is a method for randomly accessing stored video and field inspection system employing the same.

It is believed that all of the listed patents do not anticipate or make obvious the disclosed preferred embodiment(s).

### SUMMARY OF THE INVENTION

The present invention relates generally to a system and method for collecting and processing physical data obtained by various detection devices mounted to a vehicle, such as an aerial craft. Specifically, the present illustrated embodiment(s) involve the use of an aerial craft, such as a helicopter, to capture continuous visual, spatial, and related physical data, and a method for selecting certain representative pieces of the captured unprocessed data to create a discrete stream of processed data.

More particularly, the present invention relates to a system and method of monitoring physical features of a ground-based objects, such as utility power line systems, pipelines, roadways, and environmental conditions, such as vegetative growth. Monitoring may be conducted along the corridor through which the ground-based objects, such as a power transmission pole or other structures, extend. More specifically, the illustrative embodiment(s) describe a power line monitoring system and method of utilizing a helicopter that is flown along the power transmission corridor while carrying one or more pieces of equipment that provide observance and/or measurement sensors for the power line structures and other environmental conditions.

Additionally, another potential feature of the illustrated embodiment(s) is the use of an integral method for collecting, analyzing and processing a discrete stream of physical data captured from the continuous stream of unprocessed data to show specific defects that are identified in a real word environment, such as a power transmission corridor. The steps of the method may generally comprise, but are not limited to: providing a vehicle, containing a sensor mounted to the vehicle, to record a continuous stream of data, such as visual, coronal, infrared and similar data, as the vehicle traverses an object to be sensed, and a GPS recorder to record GPS data; downloading the continuous data stream and the GPS data to a data processing unit; creating, by using the data processing system, a discrete stream of data, comprising at least one piece of discrete data, from the continuous data stream; and associating the GPS data to the discrete stream of data so that each piece of discrete data has a specific and corresponding GPS location coordinate.

It is hereby noted that the prior art does not show that the creation of a discrete stream of data from a continuous data stream, includes the steps of: selecting a first segment of the continuous data stream; selecting a first discrete piece of data from the first segment to represent the first segment of continuous data; selecting a second segment of the continuous data stream; and selecting a second discrete piece of data from the second segment to represent the second segment of continuous data within the stream. In particular, it is believed that the prior art does not show that the second discrete piece of data overlaps the first discrete piece of data, nor that the second segment at least begins directly continuing from the first piece of data selected from the continuous data stream. Further, the prior art does not teach the step of creating a database containing associated GPS data coordinates and a discrete stream of data, nor the step of analyzing the discrete stream of data to identify occurrence of a certain data parametric therein, such as a structural anomaly or defect.

Additional features and advantages of the invention will be set forth in the detailed description which follows, taken in conjunction with the accompanying drawings, which together illustrate by way of example, the features of the invention.

### BRIEF DESCRIPTION OF THE DRAWINGS

Features of the present invention identified within the summary of the illustrated embodiment(s) will further described upon examination of the following detailed description in conjunction with the following figures, wherein like element numbers represent like elements throughout:

FIG. 1 is a diagram illustrating the general method of the present invention in flow chart form;

FIG. 2 is a diagram illustrating a more detailed flow chart of a subset of elements shown in FIG. 1;

FIG. 2A is a diagram illustrating a medium field of view of a visual target of the present invention;

FIG. 2B is a diagram illustrating a first wide field of view of the visual target of the present invention as also shown in FIG. 2A;

FIG. 2C is a diagram illustrating a second wide field of view adjacent to the visual target shown in FIG. 2B;

FIG. 2D is a diagram illustrating a narrow field of view of a visual target, particularly a power pole, of the present invention;

FIG. 2E is a diagram illustrating a zoom in capability of the narrow field of view sensor of the present invention;

FIG. 3 is a diagram illustrating a detailed flow chart of the data processing system of FIG. 1;

FIG. 3A is a diagram illustrating a just overlapping image algorithm as applied to sample images of a target object prior to frame reduction;

FIG. 3B is a diagram illustrating the application of the just overlapping image algorithm to sample images of FIG. 3A upon successful frame reduction;

FIG. 4 is a diagram illustrating a detailed flow chart of the data analysis system of FIG. 1; and

FIG. 5 is an illustration of a vehicle that is capable of implementing and supporting the present invention of FIG. 1.

### DETAILED DESCRIPTION OF THE ILLUSTRATED EMBODIMENT(S)

For the purpose of promoting an understanding of some of the principles of the present invention, reference will now be made to exemplary embodiment(s) that are illustrated in the figures, and specific language will be used to describe the same. It will nevertheless be understood that no limitation of the scope of the claims is thereby intended. Any alterations and further modifications of the inventive features illustrated herein, and any additional applications of these principles, which would occur to one skilled in the relevant art after having possession of this disclosure, are to be considered well within the scope of this invention.

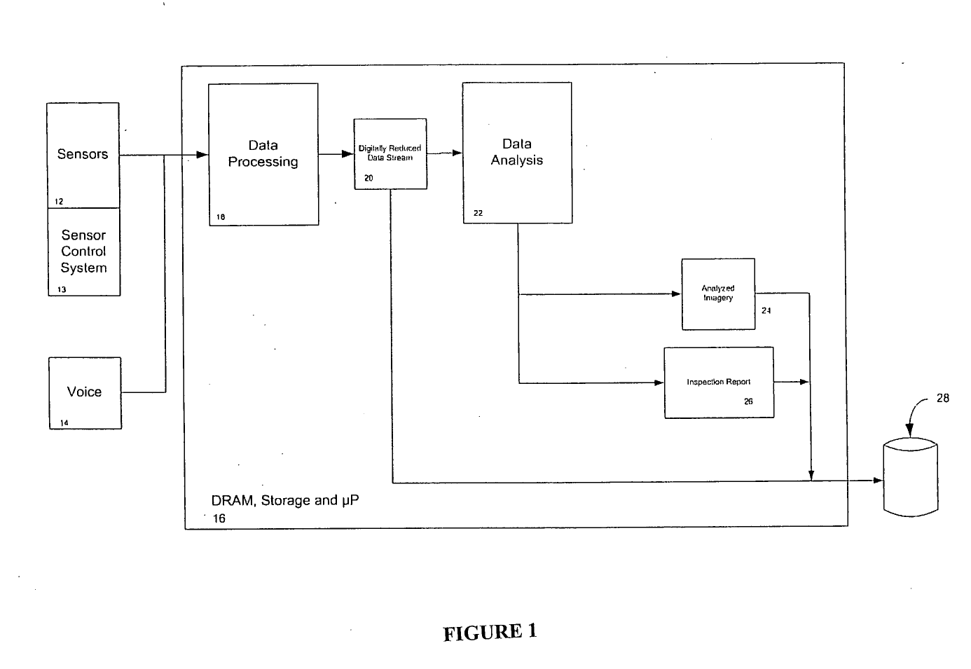

And now referring to FIG. 1, there is shown a general method of the present invention for analyzing and processing data captured from vehicle mounted sensors 12. The sensors 12 may be designed and configured to collect multi-spectral and multi-spatial imagery of physical structures or conditions, such as power lines, substations and rights of way. A sensor control system 13 is then responsible for controlling the individual sensors 12, which may involve a series of integrally attached hardware, such as a lens, a sensor pointing platform, a data collection interface, and an operator interface (not shown in the drawings). Further, an optional voice input 14 allows a vehicle operator to insert an audio report of field findings while onsite.

Upon successful capture of data by the sensors 12, a DRAM Storage and μP system (“DRAM system”) 16, facilitates data processing, data analysis and temporary data storage. It takes the raw sensor 12 and voice inputs 14 and ultimately outputs a set of geo-spatially analyzed and organized imagery 24 with the option of creating inspection reports 26. Within the DRAM system 16, a data processing system 18 may be designed and configured to organize and process the raw sensor 12 and voice data 14. The data processing system 18 accepts the sensor 12 and voice data 14 streams as an input and returns the representative set of analyzed imagery 24 and data that is synchronized in a geo-spatially (i.e., location and time) organized format.

Once the data has been processed through the data processing system 18, a data reduction step is employed to produce a digitally reduced data steam 20. This is a representative set of data from the various sensors 12, wherein multiple frame rates exist for distinct sets of data, but all sets are time and GPS stamped for correlation and synchronization.

Still referring to FIG. 1, a data analysis system 22 is responsible for receiving the digitally reduced data stream 20, and identifying certain items, defects and/or anomalies in the digitally reduced data stream 20. The data analysis system 22 then outputs a set of flagged analyzed imagery 24 data and inspection reports 26 that correspond with the digitally reduced data stream 20. The flagged attributes within the set of analyzed imagery 24 data identify defects or anomalies within a physical scene or condition monitored by the sensors 12. This subset of the raw data collected by the sensors 12 may also include information about calculated distances of objects within the images captured. The inspection reports 26, which are generated by the data analysis system 22, may contain more or less of the following information about the inspection/captured data:
1. Date when the data was collected;
2. Precise time associated with the collection of every individual piece of data or frame of film;
3. General location of the subject of the collected data;
4. Inspector's (s') names;
5. Weather conditions;
6. Latitude/longitude information associated with the specific data collected, like the center location of a single frame of film, or individual items in a frame, such as a power pole or other transmission structure, per frame and/or per identifiable item;
7. Site elevation per frame;
8. Structure type, such as power stations, poles, and/or sub-stations;
9. Structure sub-type, such as a T-type pole for example;
10. Structure information, such as pole number, line segment, and/or substation identifier;
11. Line voltage;
12. Customer reference numbers, such as a database references, barcodes, and/or engineering drawings;
13. Inspection distance from the vehicle to the object being sensed or the center of the frame 14. Image view direction;
15. Number of defects found at a given GPS location;
16. List of types of defects found per GPS location, such as hot spots, coronal discharge, broken pole structure, broken insulators, right of way infringements, and/or vegetation infringements;
17. Inspector comments; and
18. Customer comments.

Finally, still referring to FIG. 1, a database storage system 28 is shown that may be implemented on a network server or via a series of CD's/DVD's to store the processed data in digitally reduced form 20, as received directly from the data processing system 18 or from the analyzed imagery 24 and/or inspection reports 26 data streams.

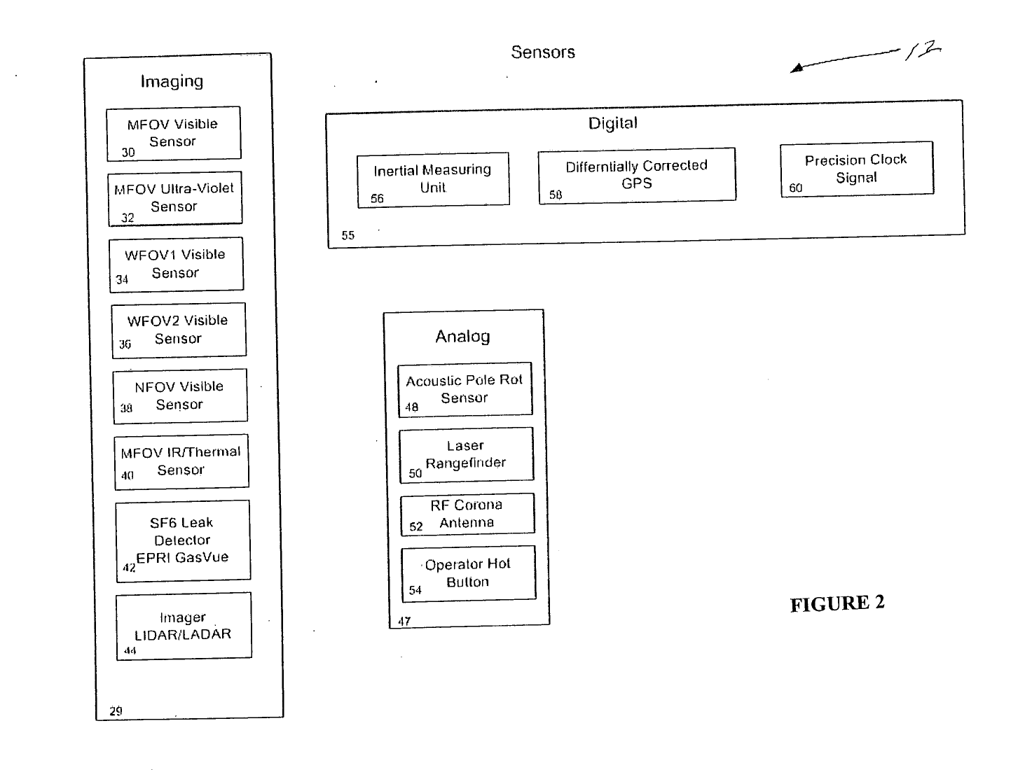

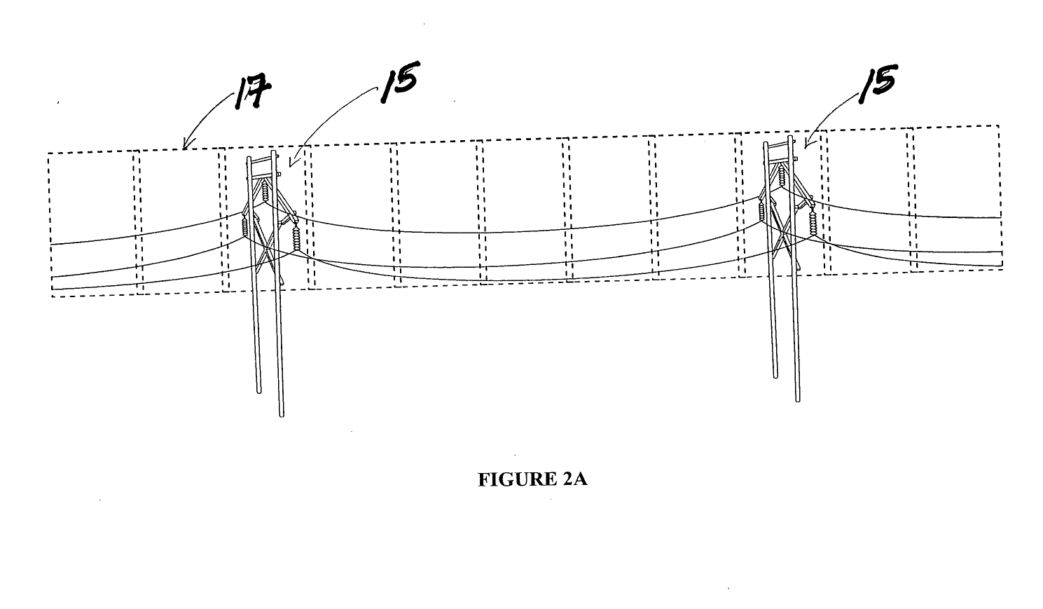

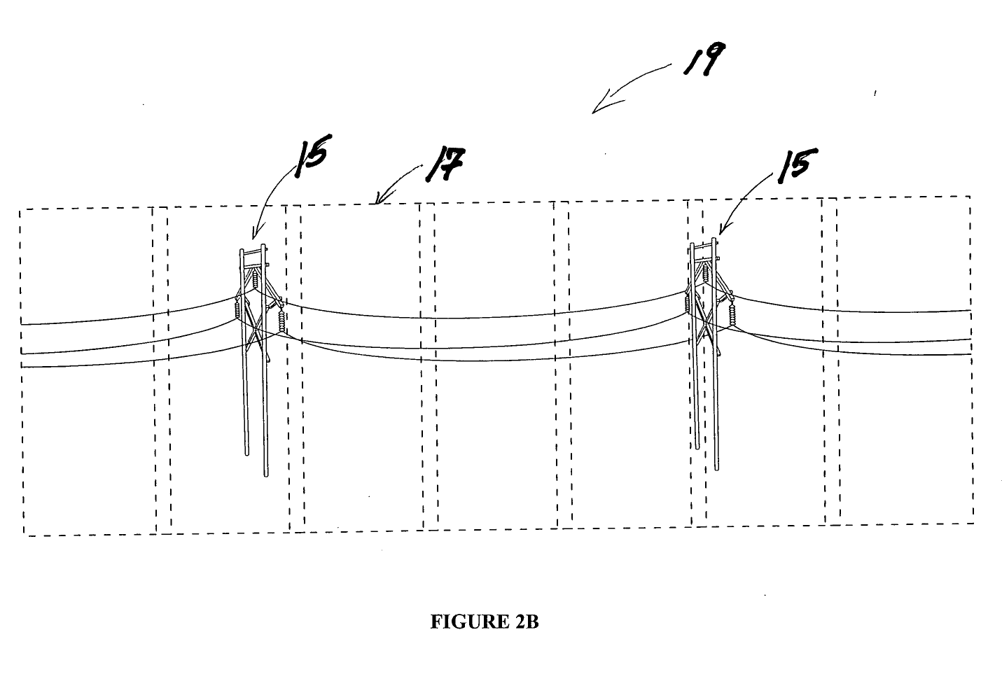

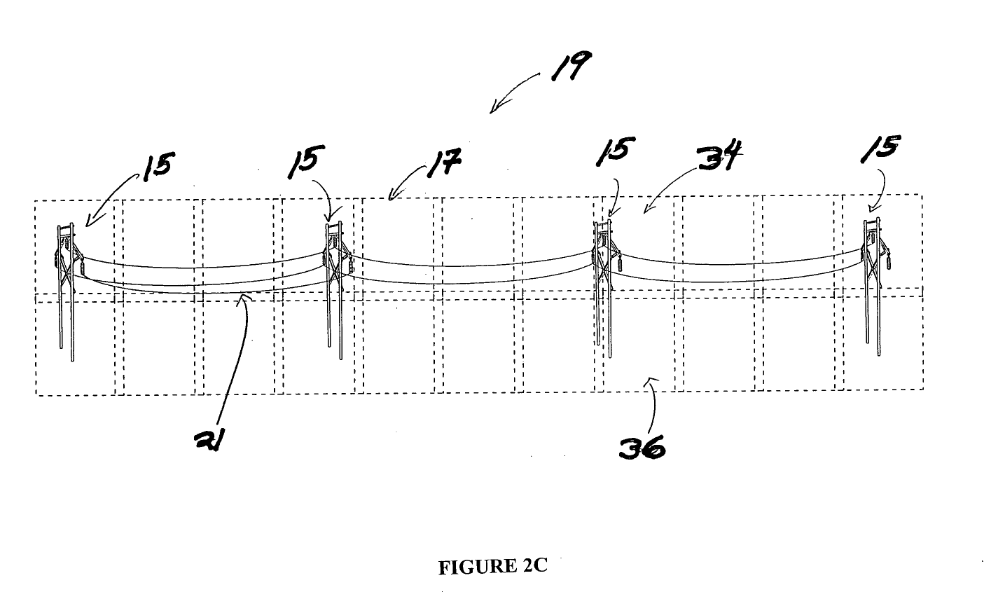

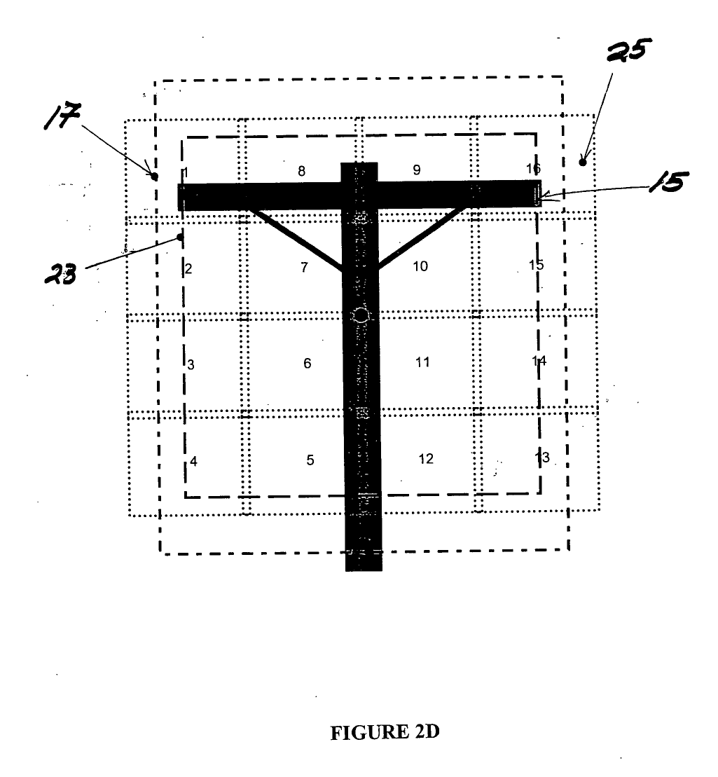

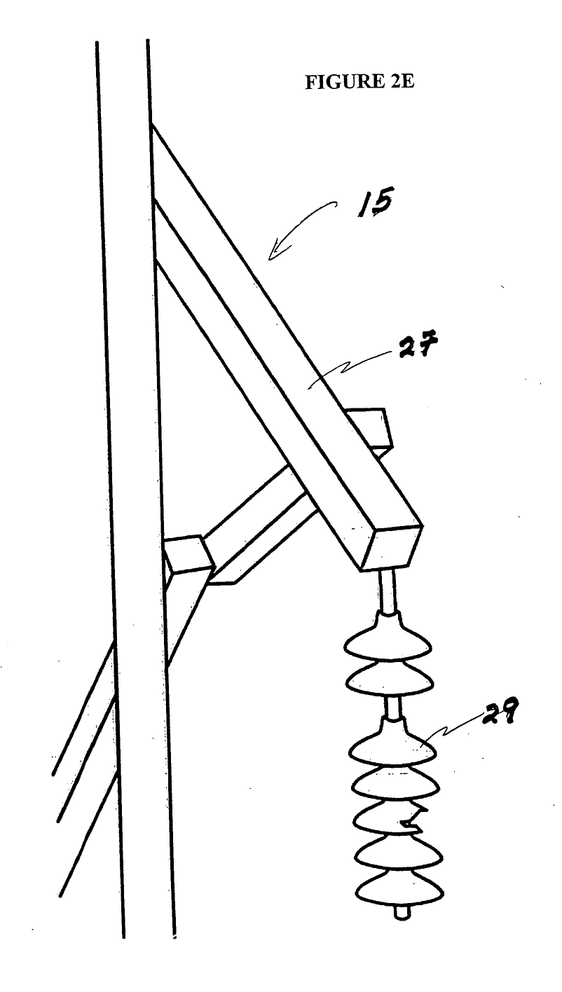

Referring now to FIG. 2, a diagram illustrating the nature and number of sensors 12 is shown and described. An imaging data 29 box is represented as containing a series of data types. Particularly, the medium field of view (“MFOV”) sensor 30 or camera is spectrally responsive in the visible spectrum of 300 nm-750 nm. As can be seen in FIG. 2A, it images the upper ⅔ to ¾ of a target structure or condition. In the present example, the target structure is a power transmission pole 15. Individual frames 17 within the medium field of view are shown by dotted lines superimposed upon the power transmission pole 15 image. The MFOV sensor 30 is designed and configured to be co-registered with other sensors, such as an infra-red (“IR”) camera, represented as MFOV IR/Thermal sensor 40, and/or an ultra-violet (“UV”) sensor or camera, represented as MFOV ultra-violet sensor 32. Infrared bands are generally broken down into near infrared, short wavelength, medium wavelength, and long wavelength regions. The present invention contemplates use of all of the regions named above.

This co-registration of images, or image registration, refers to an alignment of one image to another image of the same target or area. Thus, any two pixels existing at the same location in both images are said to be in “registration” or “co-registered”, and represent two samples for a common point of an image.

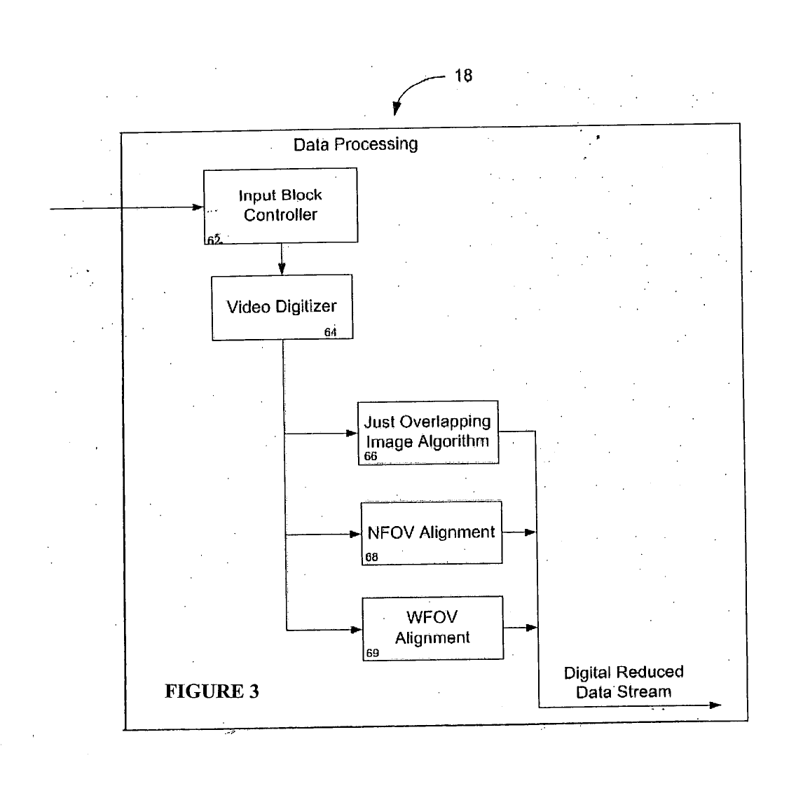

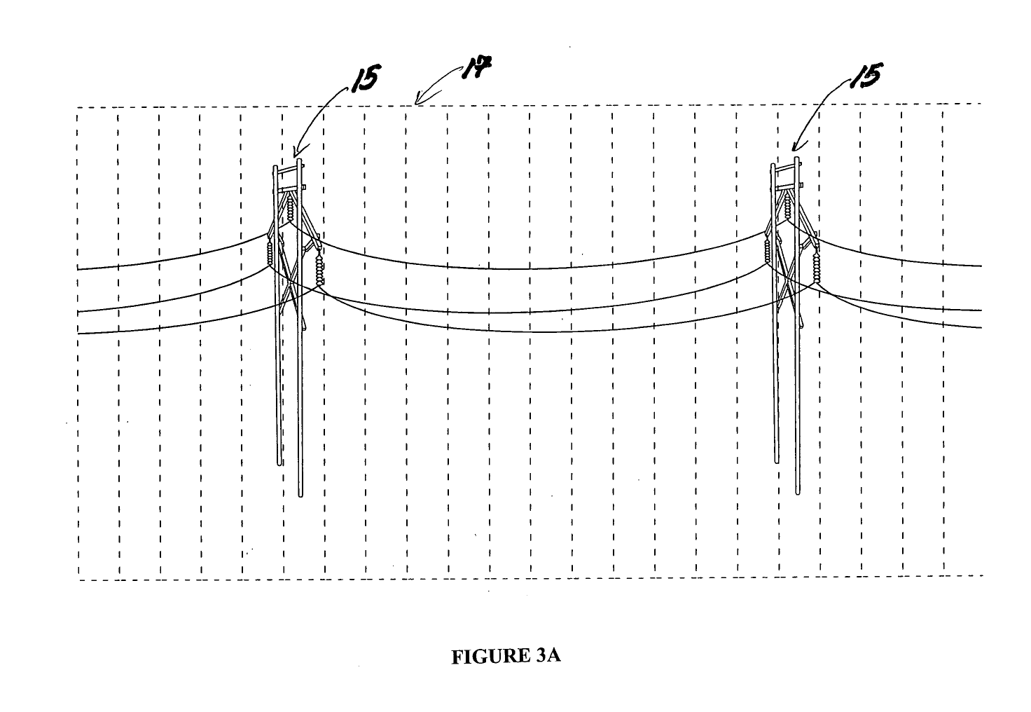

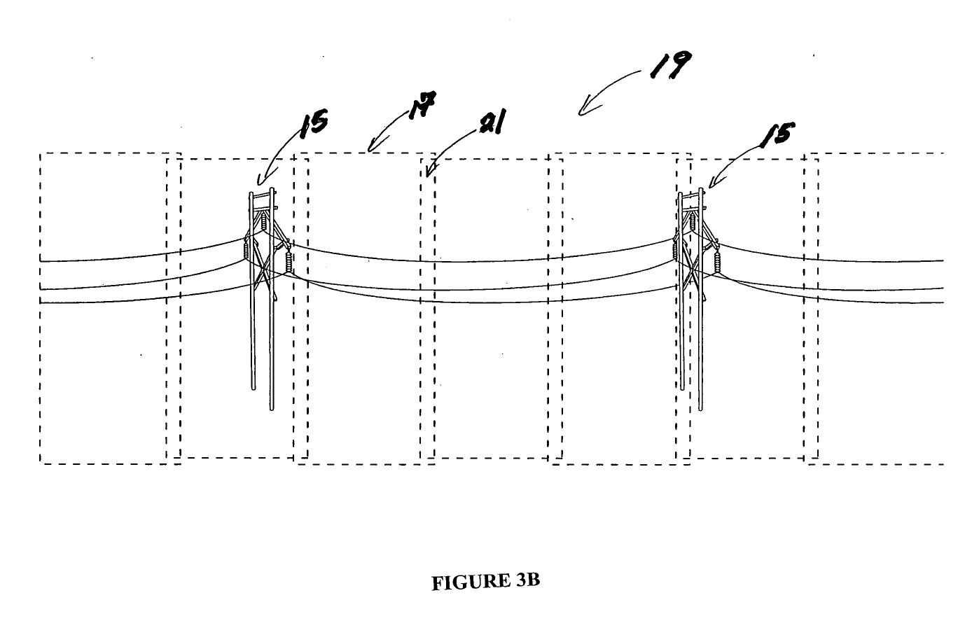

A wide field of view 1^{st} (“WFOV1”) camera or sensor 34, on the other hand, is designed and configured to record a larger physical area than the MFOV sensor 30, such as a large expanse within a right of way of a power corridor 19, as can be seen in FIG. 2B. The output from the WFOV1 sensor 34 may be combined with an output from a WVOF 2^{nd} (“WVOF2”) sensor 36 such that the WVOF2 sensor 36 records a large area of right of way of the corridor that is adjacent to the area captured by the WFOV1 sensor 34, as can be seen in FIG. 2C. The two outputs from the WFOV1 WFOV2 sensors 34, 36 may be imaged so that there is an overlap region 21 in each. When the WFOV1 sensor 34 and WFOV2 sensor 36 are combined, the two overlap regions 21 are merged. This prevents having any missed images or portions thereof. A further explanation of the image overlapping technology is described under FIG. 3.

Still referring to FIG. 2, a narrow field of view (“NFOV”) sensor or camera 38 is also illustrated as a data type to be captured and organized within the imaging data box 29. The NVOF sensor 38 is sighted through a fast steering mirror. Currently the NFOV sensor 38 is configured to capture an upper ⅓ to ½ of an object, such as the transmission pole structure 15. The fast steering mirror facilitates multiple small field of view images 25 of the power transmission pole structure 15, as can be seen in FIG. 2D. The NFOV sensor 38 has an extremely high resolution capability for finding missing bolts, cotter keys, pins, woodpecker holes, static lines, etc. For illustrative purposes only, the NFOV sensor 38 may generate 16 small field of view images 25 within the upper ¾ of the structure in a fast sequence, such as 10-100 frames 17 per second for example. It should be noted, however, that the NFOV sensor 38 may be reconfigured to generate images containing the entire target (See also FIG. 2D). These images may then be further processed to align with MFOV and WFOV images during a NFOV alignment process, to be described in further detail under the written description for FIG. 3. This alignment process is conducted within the data processing system 18, and is intended to enlarge the captured images. The NFOV sensor 38 images may also be merged with data from another sensor, such as an IR frame 23, as captured by the IR/thermal sensor 40. The NFOV sensor 38 also maintains a zoom in capability, for capturing magnified images within the target object, as can be seen in FIG. 2E. For the present illustrated embodiment(s), the target object is a power transmission pole 15, and the magnified image shows a crossarm 27 and bell 29.

FIG. 2 also shows an SF₆ Leak Detector sensor (“SF₆ sensor”) 42 within the imaging data box 29. The SF₆ sensor is an active sensor that measures Sulphur Hexaflouride, SF₆. Unlike other sampling sensors, this sensor uses a laser of a specific wavelength in the near IR region to excite molecules under examination. If SF₆ is present, the gas will fluoresce. SF₆ is an extremely toxic volatile organic compound, often found in oil used to insulate and cool transformers.

Finally, within the imaging data box 29 portion of FIG. 2, there is shown a Lidar/Ladar imaging sensor/imager (“LI sensor”) 44. The LI sensor 44 is designed and configured for LI detection and ranging or laser detection and ranging. LIDAR is a type of distance measuring equipment that performs three dimensional measurement instead of spot measurement, such as a laser rangefinder. Alternatively, but in combination, LIDAR uses a pulsed laser and detector combination, or a laser rangefinder, with some system scanning capability to sweep the laser across a field of view to measure a matrix of distances.

Still referring to FIG. 2, there is shown an analog data box 47. Within the analog data box 47, there is an acoustic pole rot sensor 48 that is designed and configured to measure the internal wood rot of a power pole, or similar structure. It functions by using a laser vibrometer to measure the vibratory response of infrasonic and audio signals aimed at specific targets. The vibratory response may then be used to identify structurally compromised portions of a power pole, or similar structure, that is the target of detection.

Also within the analog data box 47, there is shown a laser rangefinder 50. The laser rangefinder 50 is a distance measuring device. It uses a pulsed laser with a detector to determine distances to an object by measuring the time of flight of the pulse. This only measures distance to the spot on the target illuminated by the beam. An RF corona antenna 52 represents a typical loop antenna. Coronal discharge detection actually detects an arcing of electricity into the atmosphere. The arcing event is a broad band emission. If strong enough it can be seen at night as a bluish, purple aura around a transmission line or transformer. The event can be seen using an UV imager with solar blind filters. The event can also be detected by using an antenna to measure the RF wavelengths of energy that is given off as part of the arcing, which is often measured by static that can be heard on a radio when driving a vehicle under or next to a powerline. Thus, the RF corona antenna 52 measures the electric field strength of the electric field produced by power lines. If a coronal discharging event is occurring, it will be shown as a spike in a graph of the field strength.

Also shown is an operator hot button 54 that has two possible functions. The first flags a portion of the data when activated. Flagging tells the data processing system 18 and data analysis system 22 that the operator has seen a problem, defect, or anomaly and identifies it within the user's database for follow up action, such as the creation of a work order or repair request. A second function is that it allows the operator to activate and record a voice input of a segment of data for later transcription and inclusion into the final customer report.

Still referring to FIG. 2, there is shown a digital data box 55. Within the digital data box 55, there is an inertial measuring unit device (“IMU”) 56 that is designed and configured to measure accelerations of the system for increasing the precision of position calculation. The IMU 56 will measure both angular and translational accelerations. The IMU 56 is typically implemented via fiber optic gyro, but can be implemented as a set of accelerometers as well. This data is used for both sensor platform stabilization and GPS position refinement/focusing.

Also shown is a differentially corrected GPS (“DGPS”) system 58, which is designed and configured to utilize correction data to increase positional accuracy over standard GPS units. The positional margin of error is greater than the IMU 56. Generally, GPS that is used for positional information typically has a large margin of error. If smaller tolerances are required, the IMU 58 and associated components may be added to form an inertial navigational system. These two main sensor components are complimentary in nature. GPS has a slow refresh rate and is thereby particularly useful for long term measurements, which is one of the primary factors in its higher error rate. The IMU 56 is good for short term measurement at a much higher frequency—at least a two orders of magnitude greater than GPS. A drawback to the use of the IMU 58 is that it tends to drift. To solve this problem, a Kalman filter or Extended Kalman filter is used to combine two pieces of navigational information. The Kalman filter allows the IMU 56 to measure the short term navigational information but adjusts its drift by using the GPS information. These three components, GPS, IMU and Kalman filter are the basis for typical inertial navigational systems. The extended Kalman filter adds the capability of estimating the errors in the inertial navigational system.

Finally, in FIG. 2, a precision clock signal 60 is represented. The precision clock signal 60, which is typically performed by an atomic clock, is distributed via the GPS network. This clock is an extremely accurate time measurement device that is maintained by the Department of Defense. For the present invention, the precision clock signal 60 is used to stamp each sensor 12 operation so that they can be synchronized to each other. This synchronization allows for display of all sensor data for an exact GPS location at exact times.

Now referring to FIG. 3, there is shown a detailed view of the data processing system 18 of FIG. 1. Particularly, there is shown an input block controller 62 that is designed and configured to control the flow and processing of data from the sensors 12 to all of the components illustrated within the data processing system 18, as further identified and described below. Among these is a video digitizer 64, which is designed and configured to accept an analog video stream, typically National Television Standards Committee, (“NTSC”) format, which is the form of most imaging data 29 types as identified in FIG. 2. The NTSC data stream may then be converted into a digital format for processing on a computer or network.

FIG. 3 also outlines a just overlapping image algorithm 66, within the data processing system 18, which is a data reduction method that down samples continuous data or video stream into a representative set of a discrete data stream for later processing. For example it converts a continuous data stream, for example containing 30 frames 17 per second, as is illustrated in FIG. 3A, into a discrete data stream, containing 1 frame 17 per second, for example, of a video stream as illustrated in FIG. 3B.

The just overlapping image algorithm 66 is used to reduce the data set from a video stream to a sequential set of barely overlapping imagery. This reduces the workload of ground processing hardware by allowing only a representative set of images to be processed instead of the entire video stream. As is illustrated in FIG. 3B, the just overlapping imagery is formed as a composite picture of the entire powerline corridor 19. The video data set may contain approximately 600 separate video frames 17 or images for an average pole set distance, i.e. the distance between a first pole structure X, for example, and a second pole structure Y, for example. Depending on the distance between poles, a wide range of frame speeds may be employed from 100 to 1000 frames per pole set.

After the just overlapping image algorithm 66 is applied, just over 10 images are used to represent the same amount of video. In the case of the present powerline inspection system embodiment, tracking systems on the aerial vehicle's flight hardware may keep track of the number of power poles that are viewed during a flight, along with date and time stamp information to associate the data. From this data, the number of frames required to fill in the gaps between the images of each pole may be determined. More particularly, the number of images to fill in the “span” is a function of sensor 12 sample rates, distance from the target object, and the field of view of the sensor 12. Because the location of the aerial craft, the direction where a gimbal may be pointed, and the distance to the target may be known as a function of time within 6 degrees of freedom, the GPS coordinate of the center of each frame may be calculated within the data processing system 18. Thus, each image captured may be accurately geo-referenced.

Still referring to FIG. 3, a narrow filed of view (“NFOV”) alignment 68 is represented within the data processing system 18. FIG. 3B illustrates that the NFOV alignment 68 maintains a significant number of fewer frames than in the just overlapping image algorithm 66, as illustrated in FIG. 3A, for images captured in the narrow field of view. As is apparent, a significant number of frames have been reduced. Similarly, a wide field of view (“WFOV”) alignment 69 reduces the number of frames found within the just overlapping image algorithm 66 for images captured in the wide field of view. It is noted that the progression of the aforementioned steps of digitizing the video image, processing the images through the just overlapping image algorithm 66, processing narrow field of view images, and processing the wide field of view images are performed to produce the digitally reduced data stream 20.

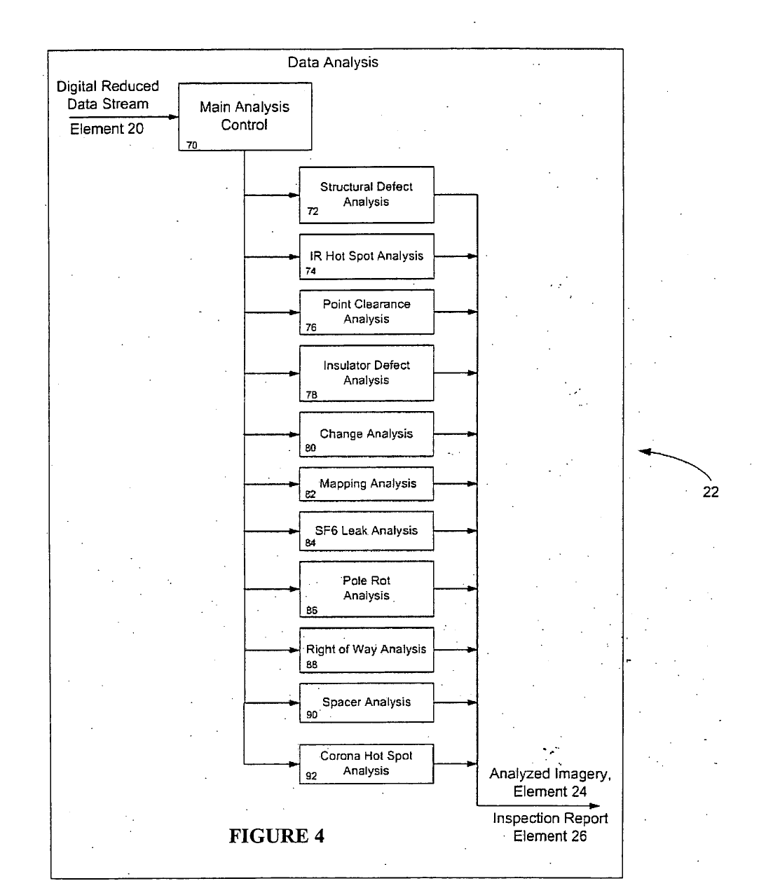

Now referring to FIG. 4, there is shown a detailed view of the data analysis system 18 of FIG. 1. Particularly, there is shown main analysis control 70, that is designed and configured to receive the digitally reduced data stream 20, and to generate reports, such as analyzed imagery reports 24 and inspection reports 26, regarding specific data captured by individual sensors 12. From the main analysis control 70, a series of data is produced, wherein the illustrated list of categories includes: structural defect analysis data 72, which contains detections of structural anomalies and/or defects within the target object, such as a power transmission pole, arm, or brace; infra-red hot spot analysis data 74, which contains detections of thermal anomalies within the target object, such as electrical lines, insulators, or other hardware; point clearance analysis data 76, which contains distance measurement data from the target object, such as a power pole, to environmental objects, such as tree branches; insulator defect analysis data 78, which contains detections of defects or damage to power insulators and bells, such as chipped, discolored, or irregularly shaped bells; change analysis data 80, which contains detected changes in data from current inspections as related to previous inspections; mapping analysis data 82, which contains precise spatial data for the target object/structure from the position of the aerial craft or vehicle from the IMU 56 and GPS 58, the pointing angle of the active sensor 12 at the time of inspection, and the distance to the structure as determined by the laser rangefinder 50; SF₆ leak analysis data 84, which contains detections of SF₆ leaks, which are extremely hazardous leaks originating transformer oil; pole rot analysis data 86, which contains detections of rotted cores within target structures, such as power poles, by utilizing sonic analysis techniques; right of way analysis data 88, which contains detected data for estimating distances from the target object, such as a power pole, to points of interest; spacer analysis data 90, which contains detections of missing structures, such as electrical line spacers; and corona hot spot analysis data 92, which contains detections of coronal anomalies on electrical lines or insulators.

Although similar, the difference between point clearance analysis data 76 and right of way analysis data 88, is that a manual point clearance algorithm is used for calculation of the point clearance analysis data 76. This algorithm is designed to estimate the shortest distance between a transmission line conductor and a designated feature or point of interest. Thus, the acquisition of point clearance analysis data 76 requires an operator to designate a point of interest within at least two frames in which it is visible. The operator then identifies left and right of points on the target object so that measurement data may be associated with the images. Right of way analysis data 88 is obtained using an encroachment analysis program, wherein the operator must designate a minimum safe distance from the target object to surrounding environmental elements, as well element classification, such as vegetation.

The mapping analysis data 82 is collected using a mapping algorithm, which is designed to measure the position and attitude of a vehicle mounted gimbal and the range to the target object, such as a power pole. From these measurements the location of the target object can be computed through trigonometric equations as related to the earth's center.

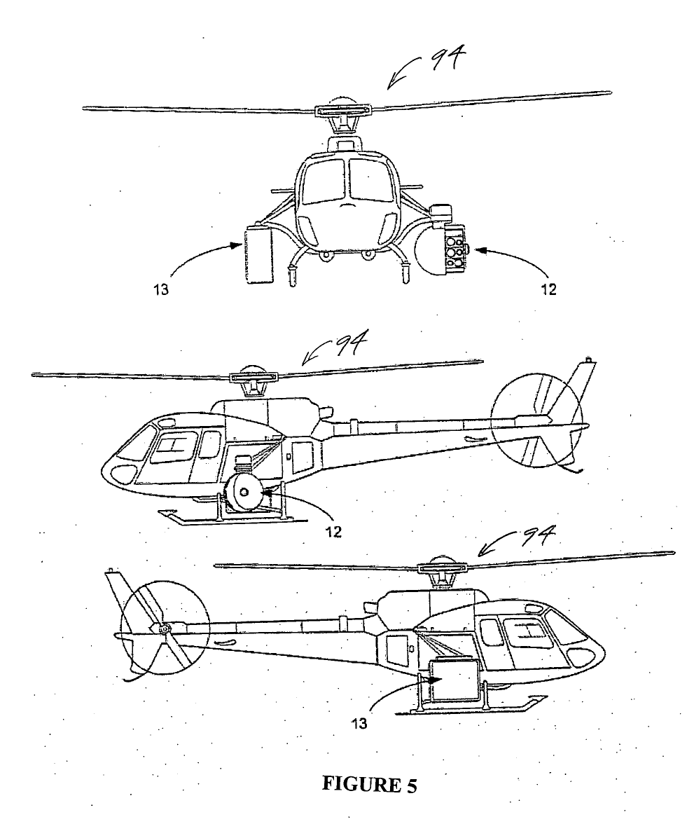

Referring now to FIG. 5, there is shown a set of diagrams illustrating an aerial craft, specifically a helicopter 94, to which the sensors 12 are mounted via mounting hardware on a first side of the helicopter 94. Also shown on an opposite side of the helicopter 94 is the sensor control system 13, also mounted via mounting hardware to the craft.

Remarks About the Illustrated Embodiment(s)

The illustrated embodiment(s) has taught several improvements over the prior art that will be readily understood by a skilled artisan after review of the present disclosure. For example, it has been discussed that to take a large amount of raw data and reduce it down to a discrete data set in the manner presently described is not known in the prior art. There are many known ways to reduce the number of visual picture frames from a motion picture camera down to a desired size and speed. Whatever the method used, however, the illustrated embodiment(s) show that there may be produced by the present invention a single frame for any given visual image or specific location within the target range, such as a power corridor. It is also taught to provide for a small overlap on the edges of each visual frame. In this fashion, there may be, for example, a 10:1, 100:1, or even larger reduction in the number of frames that are presented in the discrete data stream of the visual frames of data. With such reduced imagery, the GPS data and identified defects or anomalies can then be associated with each individual frame of the discrete data stream. A skilled artisan will understand that this will greatly reduce the overall data to be processed, resulting in a more manageable and less overwhelming amount of data to be ultimately analyzed for defects and organized into reports. This makes it possible for electronic or software analysis methods to not only identify visual defects in the visual data, but also to associate other sensor data to the digitally reduced data stream 20.

It is believed that the ability of the present invention to fuse data types is unique in comparison to the prior art. Data fusion is the combing of two or more separate data sources of the same area of interest. The combined data set still maintains the information from the sources, but the new data component contains information that otherwise would not be apparent if each source was taken by itself. In this way, it may be said that the relationship existing as a result of the combination may be quantified as 1+1=3 relationship. This is useful in the inspection of powerlines or other physical infrastructure because defects or anomalies that wouldn't normally show-up could potentially be seen where the data from two or more sensors are combined in the manner presently described.

It is pointed out, that if it has not already been made clear, that the backbone of the illustrated embodiment(s) is the use of the visual film data stream. It is this data stream that all other sensor data is associated with. It is this data that has the GPS data placed on each individual frame of the discrete data stream. It is this data that will also be the illustration to the end user for identifying what defect is associated with the selected visual frame.

Variations of the Illustrated Embodiment(s)

It is understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

For example, although the illustrative embodiment(s) has discussed the use of standard GPS, there are many forms of recording geographical locations for items such as power poles. Specifically, GPS can also be Differential GPS, the Russian GLONASS system, the FAA WAAS system or the U.S. military GPS system. Also, it is contemplated within the scope of the present to utilize differentially corrected GPS and to marry the same with inertial data. In this manner, the present invention can reduce the margin of error in capturing spatial data. This is accomplished primarily because the inertial measurement unit, along with its accompanying components, and the GPS data are complimentary. GPS is best suited for long term measurement, and IMU for short term measurement. GPS maintains a slow refresh rate and IMU maintains a much faster refresh rate. The combination of these two main sensor components creates a superior form of spatial tracking and accuracy.

Further, what is meant by associating the GPS data with the discrete data stream includes several potential methods. For example, one method may call for each piece of a continuous and/or discrete data stream frame to have an associated GPS stamp. Another example may be to include periodic stamping of one or both of the data streams. Still another example is to use only GPS stamping for frames that have identified defects or a certain data parametric therein. Finally, another example may be to have a time stamped or indexed GPS data stream and a time stamped or indexed continuous or discrete data stream that are synchronized.

The present invention is not limited to the sensors listed herein, nor to the specific types of data associated with the identified sensor types. A list of potential sensors, as matched against potential applications, is provided below as indicative, but not exhaustive, of some data types falling within the scope of the present invention (note: all sensor packages are considered to maintain GPS, DGPS with Inertial Navigational capability):
A. Power Transmission Lines and Structures
   IR Camera
   Coronal Sensor—either UV imaging camera or electric field sensor
   Digital Video Cameras of various resolution (visible light wavelengths)
   Hyperspectral Imager
   Hypertemporal Imager
   Laser Rangefinder
   IR imaging radiometer (NIR, MWIR, Thermal)
B. Pipelines
   Imaging LIDAR (for VOC mapping)
   Digital Video Cameras of various resolution (visible light wavelengths)
   Hyperspectral Imager
   Laser Rangefinder
C. Railways
   Imaging LIDAR
   Digital Video Cameras of various resolution (visible light wavelengths)
   Hyperspectral Imager
   Laser Rangefinder
D. Roadways
   Imaging LIDAR
   Digital Video Cameras of various resolution (visible light wavelengths)
   Hyperspectral Imager
   Laser Rangefinder
   IR imaging radiometer (NIR, MWIR, Thermal)
E. Watershed
   Imaging LIDAR (for biological or chemical load measurements)
   Digital Video Cameras of various resolution (visible light wavelengths)
   Hyperspectral Imager (as needed)
   Laser Rangefinder
   IR imaging radiometer (NIR, MWIR, Thermal)

Although the use of a corona sensor is discussed, the application of a typical corona sensor is broader than just measuring a corona. For example, when discussion the use of a corona, it is also meant to include a UV (“ultra violet”) sensor with ambient sunlight rejection filters or an RF (“radio frequency”) electric field sensing device. Both of these sensors are considered to be a type of corona sensor.

Data parametric is defined as any item or object that can be detected by any of the sensors. For example, and again by way of illustration only, all of the visual detection sensors (NFOV-WFOV) are designed and configured to detect a transmission line power pole, a pipeline corridor, buildings in and around the corridor, vegetation encroachment in and around the corridor, specific vegetation types (oak tree versus pine tree), broken or missing insulator bell or string, cracked power line sheaths or insulation covering, wooden power pole structural integrity or pole rot, etc. The term “sensors” as utilized herein may refer to any and all types of data detection devices named herein, and those that are nearly equivalent in function although not specifically named.

Yet another variation of the present invention contemplates the use of structural techniques such that the acoustic pole rot sensor 48 may also employ thermal analysis techniques as described in the prior art entitled “Overview of Non-Destructive Evaluation Technologies For Pole Rot Detection,” as authored by Duane Hill.

Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A method for capturing and processing physical data to show discrete defects found within a target object, the method comprising the steps of:
a) providing a vehicle, including:
i) a sensor, mounted to the vehicle, designed and configured to record a continuous stream of data as the vehicle moves relative to the target object;
ii) a global positioning system recorder, mounted to the vehicle, designed and configured to record geo-spatial data regarding the target object and vehicle;
b) downloading the continuous stream of data and the geo-spatial data to a data processing system;
c) creating, using the data processing system, a digitally reduced data stream, including at least one piece of discrete data from the continuous stream of data; and
d) associating the geo-spatial data to the digitally reduced data stream so that each piece of discrete data maintains a specific geo-spatial location.

2. The method of claim 1, wherein the target object is a power transmission corridor.

3. The method of claim 1, wherein the target object is a pipeline.

4. The method of claim 1, wherein the target object is a railway.

5. The method of claim 1, wherein the target object is a roadway.

6. The method of claim 1, wherein the target object is a watershed.

7. The method of claim 1, further comprising the step of creating a database containing the associated geo-spatial data and digitally reduced data stream.

8. The method of claim 1, wherein the data processing system is located remotely from the vehicle.

9. The method of claim 1, wherein the sensor is a wide field of view camera.

10. The method of claim 1, wherein the sensor is a medium field of view camera.

11. The method of claim 1, wherein the sensor is a narrow field of view camera.

12. The method of claim 1, wherein the sensor is an RF corona antenna.

13. The method of claim 1, wherein the sensor is a sulfur hexafluoride gas sensor.

14. The method of claim 1, wherein the sensor is an infrared sensor.

15. The method of claim 1, wherein the sensor is a LIDAR imager.

16. The method of claim 1, wherein the sensor is a LADAR imager.

17. The method of claim 1, wherein the sensor is an acoustic pole rot sensor.

18. The method of claim 1, wherein the sensor is a laser rangefinder.

19. The method of claim 1, wherein the sensor is an intertial measurement unit.

20. The method of claim 1, wherein the sensor is a differentially corrected global positioning system.

21. The method of claim 1, wherein the sensor is a precision clock.

22. The method of claim 1, further comprising the step of analyzing the digitally reduced data stream to identify occurrences of a certain data parametric therein.

23. The method of claim 22, wherein the data parametric is vegetative encroachment into the target object.

24. The method of claim 22, wherein the data parametric is structural defects within the target object.

25. The method of claim 22, wherein the data parametric is structural elements missing from the target object.

26. The method of claim 22, wherein the data parametric is change in structural elements within the target object over a period of time.

27. The method of claim 22, wherein the data parametric is emission of sulfur hexafluoride gas from the target object.

28. The process of claim 22, wherein the data parametric is temperature.

29. The method of claim 1, wherein the creation of the digitally reduced data stream from the continuous stream of data further comprises the steps of:
a) selecting a first segment of the continuous stream of data;
b) selecting a first discrete piece of data from the first segment, to represent the first segment of continuous stream of data;
c) selecting a second segment of the continuous stream of data; and
d) selecting a second discrete piece of data from the second segment to represent the second segment of continuous stream of data.

30. The method of claim 23, wherein the second discrete piece of data overlaps the first discrete piece of data.

31. A method of inspecting a power corridor for defects and environmental conditions, the method comprising the steps of:
a) providing an aircraft, including:
i) a sensor, mounted to the aircraft, designed and configured to record a continuous stream of data as the aircraft traverses a length of the power corridor; and
ii) a global positioning system recorder, mounted to the aircraft, designed and configured to record geo-spatial data that is synchronous to the continuous stream of data;
b) downloading the continuous stream of data to a data processing system;
c) creating a digitally reduced data stream from the continuous stream of data, wherein the digitally reduced data stream contains data processed within the data processing system;
d) analyzing the digitally reduced data stream to identify occurrences of a certain data parametric therein; and
e) generating analyzed imagery and inspection report databases containing the digitally reduced data stream with both the geo-spatial data and the identified data parametric synchronized to the digitally reduced data stream.

32. The method of claim 31, wherein the sensor is a wide field of view camera.

33. The method of claim 31, wherein the sensor is a medium field of view camera.

34. The method of claim 31, wherein the sensor is a narrow field of view camera.

35. The method of claim 31, wherein the sensor is an RF corona antenna.

36. The method of claim 31, wherein the sensor is a sulfur hexafluoride gas sensor.

37. The method of claim 31, wherein the sensor is an infrared sensor.

38. The method of claim 31, wherein the sensor is a LIDAR imager.

39. The method of claim 31, wherein the sensor is a LADAR imager.

40. The method of claim 31, wherein the sensor is an acoustic pole rot sensor.

41. The method of claim 31, wherein the sensor is a laser rangefinder.

42. The method of claim 31, wherein the sensor is an intertial measurement unit.

43. The method of claim 31, wherein the sensor is a differentially corrected global positioning system.

44. The method of claim 31, wherein the sensor is a precision clock.

45. The method of claim 31, wherein the data parametric is vegetative encroachment into the power corridor.

46. The method of claim 31, wherein the data parametric is structural defects within the power corridor.

47. The method of claim 31, wherein the data parametric is structural elements missing from the target object.

48. The method of claim 31, wherein the data parametric is change in structural elements within the target object over a period of time.

49. The method of claim 31, wherein the data parametric is emission of sulfur hexafluoride gas from the target object.

50. The process of claim 31, wherein the data parametric is temperature.

51. A system architecture for capturing and processing physical data to show discrete defects found within a target object, comprising:
a) a sensor, designed and configured to be mounted to a vehicle and to collect the physical data about the target object;
b) a sensor control system, integrally connected to the sensor, designed and configured to control the sensor;
c) a data processing system, integrally connected to the sensor control system, designed and configured to receive the physical data from the sensor control system and to synchronize the physical data into a geo-spatially organized format;
d) a digitally reduced data stream, derived from the physical data within the data processing system, designed and configured to retain multiple frame rates for distinct subsets of the physical data;
e) a data analysis system, designed to receive the digitally reduced data stream, and configured to identify defects and anomalies within the target object; and
f) a set of analyzed imagery data and inspection reports, generated by the data analysis system that correspond with the digitally reduced data stream and identified defects and anomalies within the target object.

52. The system architecture of claim 51, wherein the sensor is a wide field of view camera.

53. The system architecture of claim 51, wherein the sensor is a medium field of view camera.

54. The system architecture of claim 51, wherein the sensor is a narrow field of view camera.

55. The system architecture of claim 51, wherein the sensor is an RF corona antenna.

56. The system architecture of claim 51, wherein the sensor is a sulfur hexafluoride gas sensor.

57. The system architecture of claim 51, wherein the sensor is an infrared sensor.

58. The system architecture of claim 51, wherein the sensor is a LIDAR imager.

59. The system architecture of claim 51, wherein the sensor is a LADAR imager.

60. The system architecture of claim 31, wherein the sensor is an acoustic pole rot sensor.

61. The system architecture of claim 51, wherein the sensor is a laser rangefinder.

62. The system architecture of claim 51, wherein the sensor is an intertial measurement unit.

63. The system architecture of claim 51, wherein the sensor is a differentially corrected global positioning system.

64. The system architecture of claim 51, wherein the sensor is a precision clock.

65. The system architecture of claim 51, wherein the environmental condition is vegetative encroachment into the target object.

66. The system architecture of claim 51, wherein the defect is a structural defect within the target object.

67. The system architecture of claim 51, wherein the anomaly is a missing structural element from the target object.

68. The system architecture of claim 51, wherein the anomaly is a change in structural elements within the target object over a period of time.

69. The system architecture of claim 51, wherein the anomaly is an emission of sulfur hexafluoride gas from the target object.

70. The system architecture of claim 51, wherein the anomaly is temperature.
